(19) United States
(12) Patent Application Publication
(10) Pub. No.: US 2026/0370460 A1
(43) Pub. Date: Nov. 19, 2026

(54) METHOD AND APPARATUS FOR PERFORMING CLIENT CREDENTIAL ASSERTION IN WIRELESS COMMUNICATION SYSTEM

(71) Applicant: Samsung Electronics Co., Ltd., Suwon-si, Gyeonggi-do (KR)

(72) Inventors: Ramesh Chandra VUPPALA, Bangalore (IN); Neha SHARMA, Bangalore (IN); Anshuman NIGAM, Bangalore (IN); Donghyun JE, Suwon-si (KR); Dongmyoung KIM, Suwon-si (KR)

(21) Appl. No.: 18/764,900

(22) Filed: Jul. 5, 2024

(30) Foreign Application Priority Data
Jul. 7, 2023 (IN) 202341045831
Jun. 13, 2024 (IN) 2023 41045831

(51) Int. Cl. H04L 9/08; H04L 9/32

(52) U.S. Cl. CPC H04L 9/0852; H04L 9/3213; H04L 9/3247; H04L 2209/80

(57) ABSTRACT

The disclosure relates to a fifth generation (5G) communication system or a sixth generation (6G) communication system for supporting higher data rates beyond a fourth generation (4G) communication system such as long term evolution (LTE). The disclosure provides techniques for performing client credential assertion based authentication and authorization in a wireless communication system. A method performed by a network entity for performing client credential assertion (CCA) based authentication and authorization of the network entity is provided. The method includes sending, by the network entity to a network repository function (NRF), a first service request, wherein the sending of the first service request includes encrypting, by the network entity, a CCA token using a key encapsulation mechanism (KEM), wherein the KEM is based on a predefined post quantum cryptography (PQC) mechanism, signing, by the network entity, the encrypted CCA token using a digital signature to generate a quantum secure CCA token, wherein the quantum secure CCA token is a digitally signed encrypted CCA token and the digital signature is based on the predefined PQC mechanism, and sending, by the network entity to the NRF, the quantum secure CCA token with the first service request, and receiving, by the network entity from the NRF, a service response to the first service request.

### CROSS-REFERENCE TO RELATED APPLICATION(S)

This application is based on and claims priority under 35 U.S.C. § 119(a) of an Indian Provisional patent application number 202341045831, filed on Jul. 7, 2023, in the Indian Patent Office, and of an Indian Complete patent application No. 202341045831, filed on Jun. 13, 2024, in the Indian Patent Office, the disclosure of each of which is incorporated by reference herein in its entirety.

### BACKGROUND

### 1. Field

The disclosure relates to a field of wireless communication networks. More particularly, the disclosure relates to a method and apparatus for performing client credential assertion (CCA) in a wireless communication system.

### 2. Description of Related Art

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around the year 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to i33mplement 6G communication systems in a terahertz (THz) band (for example, 95 gigahertz (GHz) to 3 THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for performing client credential assertion (CCA) in a wireless communication system.

Additional aspects will be set forth in part in the description which follows and, in part, will be apparent from the description, or may be learned by practice of the presented embodiments.

In accordance with an aspect of the disclosure, a method performed by a network entity for performing client credential assertion (CCA) based authentication and authorization of the network entity is provided. The method includes sending, by the network entity to a network repository function (NRF), a first service request, wherein sending the first service request includes encrypting, by the network entity, a CCA token using a key encapsulation mechanism (KEM), wherein the KEM is based on a predefined post quantum cryptography (PQC) mechanism, signing, by the network entity, the encrypted CCA token using a digital signature to generate a quantum secure CCA token, wherein the quantum secure CCA token is a digitally signed encrypted CCA token and the digital signature is based on the predefined PQC mechanism, and sending, by the network entity to the NRF, the quantum secure CCA token with the first service request, and receiving, by the network entity from the NRF, a service response to the first service request.

In accordance with another aspect of the disclosure, a method performed by a network function (NF) service consumer for accessing service provided by an NF service producer is provided. The method includes receiving, by the NF service consumer from a network repository function (NRF), a quantum secure access token, wherein the quantum secure access token is generated by the NRF and signed using a digital signature, wherein the digital signature is based on a predefined post quantum cryptography (PQC) mechanism, sending, by the NF service consumer to the NF service producer, the quantum secure access token in an NF service request, and receiving, by the NF service consumer from the NF service producer, an NF service response, wherein the NF service response is based on a validation of the quantum secure access token using the predefined PQC mechanism at the NF service producer.

In accordance with another aspect of the disclosure, a network entity for performing client credential assertion (CCA) based authentication and authorization of the network entity is provided. The network entity includes memory, and a processor coupled to the memory and configured to send a first service request to a network repository function (NRF), wherein the processor sends the first service request by encrypting a CCA token using a key encapsulation mechanism (KEM), wherein the KEM is based on a predefined post quantum cryptography (PQC) mechanism, signing the encrypted CCA token using a digital signature to generate a quantum secure CCA token, wherein the quantum secure CCA token is a digitally signed encrypted CCA token and the digital signature is based on the predefined PQC mechanism, and sending, to the NRF, the quantum secure CCA token with the first service request, and receive, from the NRF, a service response to the first service request, wherein the service response is determined based on decryption, at the NRF, of the quantum secure CCA token using a decryption technique, and wherein the decryption technique is based on the predefined PQC mechanism.

In accordance with another aspect of the disclosure, a network entity for accessing service provided by a network function (NF) service producer is provided. The network entity includes memory, and a processor coupled to the memory and configured to receive a quantum secure access token from a network repository function (NRF), wherein the quantum secure access token is generated by the NRF and signed using a digital signature, wherein the digital signature is based on a predefined post quantum cryptography (PQC) mechanism, send, to the NF service producer, the quantum secure access token in an NF service request, and receive, from the NF service producer, an NF service response, wherein the NF service response is based on a validation of the quantum secure access token using the predefined PQC mechanism at the NF service producer.

In accordance with another aspect of the disclosure, one or more non-transitory computer-readable storage media storing one or more computer programs including computer-executable instructions that, when executed by one or more processors of a network entity individually or collectively, cause the network entity to perform operations are provided. The operations include sending, by the network entity to a network repository function (NRF), a first service request, wherein the sending of the first service request comprises encrypting, by the network entity, a client credential assertion (CCA) token using a key encapsulation mechanism (KEM), wherein the KEM is based on a predefined post quantum cryptography (PQC) mechanism, signing, by the network entity, the encrypted CCA token using a digital signature to generate a quantum secure CCA token, wherein the quantum secure CCA token is a digitally signed encrypted CCA token and the digital signature is based on the predefined PQC mechanism, and sending, by the network entity to the NRF, the quantum secure CCA token with the first service request, and receiving, by the network entity from the NRF, a service response to the first service request.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other features, aspects, and advantages of certain embodiments of the disclosure will be more apparent from the following description taken in conjunction with the accompanying drawings, in which:

FIG. 1 illustrates a representation of client credential assertion (CCA) protocol as per third generation partnership project (3GPP) standards, according to the related art;

FIG. 2 illustrates a representation of OAuth or OAuth 2.0 framework, according to the related art;

FIG. 3 illustrates a problem scenario associated with insecure cryptographic algorithms in the CCA interface, according to the related art;

FIG. 4 illustrates a solution scenario corresponding to the problem scenario of FIG. 3, according to an embodiment of the disclosure;

FIG. 5 illustrates a flow diagram depicting a method for performing CCA based authentication and authorization of a network entity, according to an embodiment of the disclosure;

FIG. 6 illustrates a problem scenario associated with incompatibilities between network function (NF) and service communication proxy (SCP), according to an embodiment of the disclosure;

FIG. 7 illustrates a first solution scenario corresponding to second problem scenario of FIG. 6, according to an embodiment of the disclosure;

FIG. 8 illustrates a second solution scenario corresponding to problem scenario of FIG. 6, according to an embodiment of the disclosure;

FIG. 9 illustrates an example representation of a problem associated with insecure cryptographic algorithms in the OAuth interface, according to an embodiment of the disclosure;

FIG. 10 illustrates a solution scenario corresponding to the problem scenario of FIG. 9, according to an embodiment of the disclosure;

FIG. 11 illustrates a flow diagram depicting a method for accessing service provided by the NF service producer, according to an embodiment of the disclosure;

FIG. 12 illustrates a solution scenario corresponding to the problem scenario of FIG. 9, according to an embodiment of the disclosure;

FIG. 13 illustrates a diagram of a system for performing CCA based authentication and authorization of a network entity, according to an embodiment of the disclosure;

FIG. 14 illustrates a diagram of a system for accessing service provided by the NF service producer, according to an embodiment of the disclosure;

FIG. 15 illustrates a block diagram of a configuration of a UE according to an embodiment of the disclosure; and

FIG. 16 illustrates a block diagram of a configuration of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The disclosure provides techniques for post quantum secure authentication protocol for Client Credentials Assertion (CCA) and OAuth between various network entities and procedures in the wireless communication systems of both 5^{th} Generation (5G) and 6^{th} Generation (6G) networks. The disclosure defines techniques for securing CCA and OAuth protocols from attacks on quantum machines. The quantum safe crypto algorithm as disclosed herein refers to either post quantum cryptography algorithms or hybrid algorithm or any quantum safe homomorphic algorithm. Hybrid algorithms are a combination of legacy and quantum safe crypto algorithms. Post quantum based crypto algorithms are preferred to be safe against quantum attacks and for their faster key generation mechanism. Embodiments herein define techniques for introducing such quantum safe crypto algorithms into CCA and OAuth procedures of 6G wireless communication systems. Embodiments herein define a mechanism for replacing legacy algorithms with cipher suites, signatures of quantum safe crypto algorithms. embodiments described herein define a mechanism to address incompatibility issues between SCPs in CCA for migrating to quantum safe crypto algorithms support. Embodiments herein define rejection-handling scenarios due to migration towards PQC in CCA. Embodiments herein also define security policy mechanisms to resolve the incompatibility issues by introducing new security mechanisms in capability negotiation between SCP entities. Some embodiments described herein define techniques to address incompatibility issues between SCPs in CCA for migrating to quantum safe crypto algorithms support. Embodiments herein define rejection-handling scenarios due to migration towards PQC in CCA. Embodiments herein also define new security policy mechanisms to resolve the incompatibility issues by introducing new security mechanisms in capability negotiation between SCP entities.

In recent years, several broadband wireless technologies have been developed in order to meet a growing number of broadband subscribers by providing better applications and services. For example, a Second Generation (2G) wireless communication system was developed to provide voice services while ensuring the mobility of users. Similarly, a Third Generation (3G) wireless communication was developed to support voice service as well as data services. Further, a Fourth Generation (4G) wireless communication system has been developed to provide high-speed data service. However, the fourth generation (4G) wireless communication system suffers from a lack of resources to meet the growing demand for high-speed data services. This problem is solved by Fifth Generation (5G) wireless communication system, which provides ultra-reliability and supports low latency applications. A major component of 3GPP specification associated with the standardization of 5G describes Client Credentials Assertion (CCA) in 5G. CCA is used by a client to provide client authenticity while communicating via an intermediate network node. For example, CCA is used by a network function (NF) service consumer for authentication while communicating with a Network Repository Function (NRF).

The disclosure provides techniques for performing client credential assertion based authentication and authorization in a wireless communication system. The method comprises sending a first service request to a network repository function (NRF), wherein sending the first service request comprises: encrypting a CCA token using a key encapsulation mechanism (KEM), signing the encrypted CCA token using a digital signature to generate a quantum secure CCA token, wherein the quantum secure CCA token is a digitally signed encrypted CCA token, and sending the quantum secure CCA token with the first service request. The KEM and the digital signature are based on a predefined post quantum cryptography (PQC) mechanism. The method comprises receiving a service response to the first service request from the NRF.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

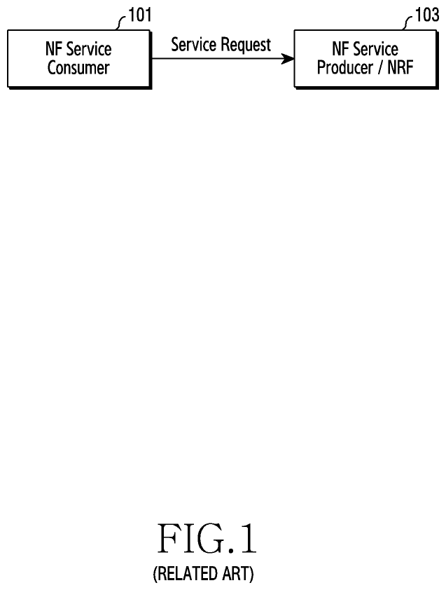

FIG. 1 illustrates a representation of CCA protocol as per 3GPP standards, according to the related art.

Referring to FIG. 1, an NF service consumer 101 generates a CCA-based token and signs the token using a public key. The NF service consumer 101 then includes the token in a service request message and transmits the request to an NF service producer/NRF 103. The CCA includes the NF Service Consumer's NF Instance identification (ID) that can be checked against the certificate by the NF Service Producer. The CCAs are used generally for both NF-NRF communication and NF-NF communication. The CCAs are JavaScript Object Notation (JSON) web tokens (JWTs) and are encrypted using legacy cryptographic algorithms like Rivest, Shamir, Adleman (RSA) algorithm or Elliptical Curve Diffie Hellman (ECDH) algorithms. CCA tokens are signed and secured with digital signatures based on JSON Web Signature (JWS). Further, Service Communication Proxy (SCP) is an entity that NFs sometimes use to communicate to other NFs or NRFs. SCPs also verify the signatures of CCA along with NF producer or NRF.

OAuth 2.0 is an industry-standard protocol for authorization. OAuth 2.0 focuses on client developer simplicity while providing specific authorization flows for web applications, desktop applications, mobile phones, and living room devices.

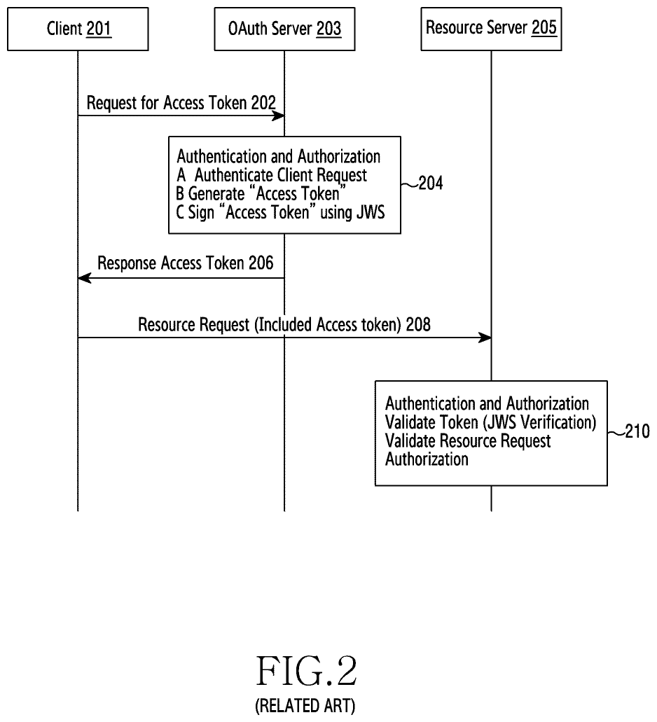

FIG. 2 illustrates a representation of OAuth or OAuth 2.0 framework, according to the related art.

Referring to FIG. 2, an OAuth 2.0 authorization framework enables a third-party application to obtain limited access to a Hypertext Transfer Protocol (HTTP) service, either on behalf of a resource server by orchestrating an approval interaction between the resource server and the HTTP service, or by allowing the third-party application to obtain access on its own behalf. For example, at operation 202, a client 201 transmits a request for an access token to an OAuth server 203. Then, at operation 204, the OAuth server 203 generates an access token and signs the token using the public key of a resource server 205, such as JSW. At operation 206, the OAuth server 203 shares the access token with the client 201. At operation 208, the client 201 uses the signed access token to transmit a resource request to the resource server 205 for accessing services provided by the resource server 205. At operation 210, the OAuth server 203 validates the access token using JWS verification and validates the resource request.

In 6G wireless communication systems, quantum computers or machines are widely used which is a threat to current wireless security systems. The quantum computer is a computer, which makes use of quantum-mechanical effects. The quantum-mechanical effects include superposition, which allows quantum bits (qubits) to exist in a combination of several states at once, and entanglement, which further allows connections between separate quantum systems such that they cannot be described independently. There exist quantum algorithms that use quantum-mechanical effects to solve certain cryptographic problems more efficiently than they may be solved on a classical computer. For example, Shor's quantum algorithm for integer factorization runs in polynomial time on a quantum computer. A variant of Shor's algorithm enables a quantum computer to calculate discrete logarithms in polynomial time, both over finite fields and elliptic curves. Another quantum algorithm is Grover's algorithm which is used for polynomial speed-up in unstructured search. The N-bit key for a cipher is recovered with O(2N/2) serial quantum operations in Grover's algorithm, which affects 128-bit Advanced Encryption Standard (AES) based algorithms, such as 128-NR encryption algorithm (NEA)2 used in 5G. Accordingly, these quantum algorithms render several other public-key cryptosystems insecure, including RSA, Diffie-Hellman (DHE), and Elliptic Curve Diffie-Hellman (ECDH). Also, these algorithms are a threat to symmetric cryptography and the security of hash algorithms like Secure Hash Algorithm (SHA)-256.

To counter the threat of quantum computing to asymmetric cryptography, it is necessary to adapt quantum-resistant algorithms also called Post Quantum Cryptography (PQC) algorithms into 3GPP to secure the CCA and OAuth from quantum attacks.

Homomorphic encryption algorithms make it possible to perform mathematical operations on encrypted data without having to decrypt any part of it and they are providing quantum safety that helps in protecting CCA and OAuth protocols from quantum attacks.

Therefore, there lies a need for wireless communication networks including beyond 5G network and 6G network wireless communication systems that can address the above-mentioned problems and adapt to quantum-safe algorithms for enhanced security.

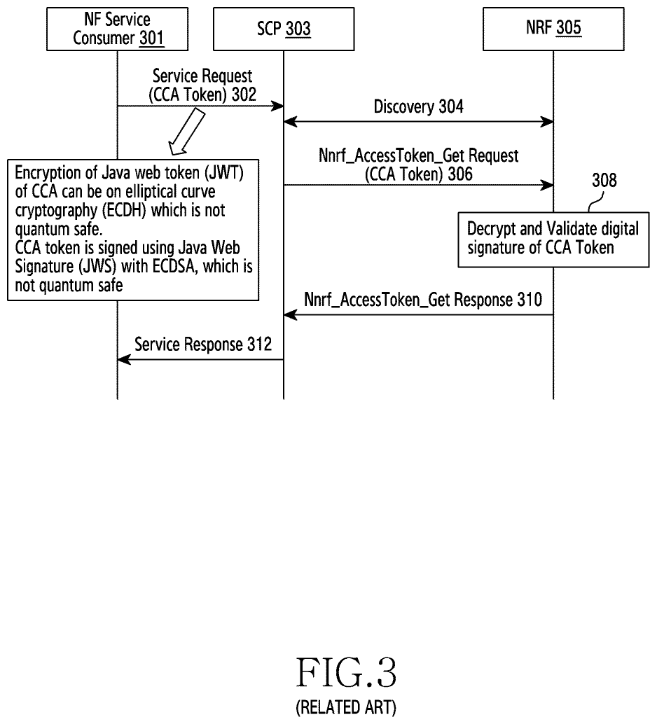

The disclosed techniques are further explained in detail with respect to FIGS. 3 to 14.

In an embodiment, the terms “network entity” and “NF service consumer” have been used interchangeably throughout the specification and drawings. Further, the terms “PQC” and “PQC mechanism” have been used interchangeably throughout the specification and drawings. Also, the terms “algorithm” and “mechanism” have been used interchangeably throughout the specification and drawings.

FIG. 3 illustrates a problem scenario associated with insecure cryptographic algorithms in the CCA interface, according to the related art.

Particularly, FIG. 3 illustrates a sequence flow diagram of related security and authentication mechanisms in the 5G wireless communication system. The related security and authentication mechanisms do not have quantum-safe mechanisms in the encryption and authentication of CCA tokens among NFs, SCPs, and NRFs. The sequence flow diagram may include several operations outlined as follows.

Referring to FIG. 3, at operation 302, an NF service consumer 301 transmits a service request using a CCA token to an SCP 303. At operation 304, the SCP 303 performs a discovery operation to discover an NRF 305. The CCA token is based on the Java web token (JWT). The CCA token is encrypted using legacy algorithms like Elliptical Curve Diffie-Hellman (ECDH) or RSA for encryption as described in RFC 7519, which is not quantum-safe. The CCA token is signed using Java Web Signature (JWS) with the Elliptic Curve Digital Signature Algorithm (ECDSA) or RSA as described in RFC 7515, which is not quantum-safe either. Then, at operation 306, the SCP 303 transmits a Nnrf_AccessToken_Get Request using the CCA token to the NRF 305. At operation 308, the NRF (also referred to as an NF producer) decrypts the CCA token and validates the signature of the CCA token. Intermediate Service Communication Proxies (SCPs) can also validate the authenticity of NF service consumer 301 by verifying the digital signature. At operation 310, the NRF 305 transmits Nnrf_AccessToken_Get Response to the SCP 303. At operation 312, the SCP 303 transmits the service response to the NF service consumer 301. The related algorithms used to encrypt and sign the CCA taken are prone to attacks. An attacker using quantum machines can break all these legacy algorithms based on RSA and elliptical curve cryptography. Therefore, the attackers using quantum machines can break the encryption and decode the CCA tokens containing NF instance information, timestamp, expiration times, and NF producer service type and use them for replay attacks, Denial of service (DoS), Distributed denial of service (DDoS) attacks in future. The attackers using quantum machines can also break these legacy digital signature-based algorithms and perform man-in-the-middle (MITM), impersonation attacks, and spoofing where the attacker acts as the NF service consumer 301 and requests various services from different NFs. The various services may include private and sensitive information like various authentication vectors, cryptographic material, and location information, e.g., Cell ID and Physical Cell ID. Hence, securing the CCA tokens with quantum-safe crypto algorithms in the 6G wireless communication system mitigates such kinds of attacks.

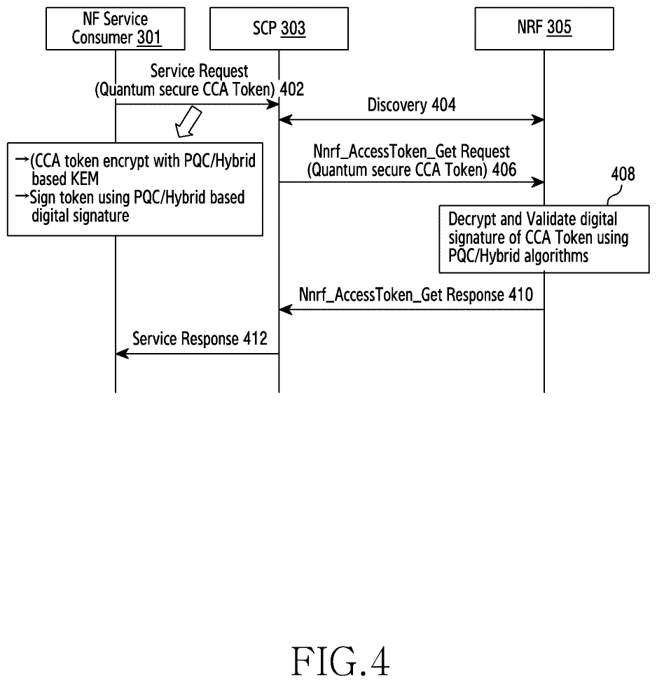

FIG. 4 illustrates a solution scenario corresponding to the problem scenario of FIG. 3, according to an embodiment of the disclosure. Particularly, FIG. 4 illustrates a sequence flow diagram of a disclosed solution for profiles of quantum-safe algorithms, cipher suites, and signatures to use in CCA. Embodiments herein define a mechanism for replacing legacy algorithms with cipher suites, signatures of quantum-safe crypto algorithms into CCA encryption, and authentication procedures of 6G wireless communication systems. The quantum-safe crypto algorithm as disclosed herein refers to one of post quantum cryptography (PQC) mechanisms, hybrid PQC mechanisms, and any quantum-safe homomorphic mechanisms. Hybrid mechanisms are a combination of legacy and quantum-safe crypto algorithms. PQC mechanisms are preferred to be safe against quantum attacks and for their faster key generation mechanism. Some examples of PQC mechanisms include Kyber, BIKE, Mc-Alliece, etc. An example of a PQC digital signature mechanism is Di-lithium.

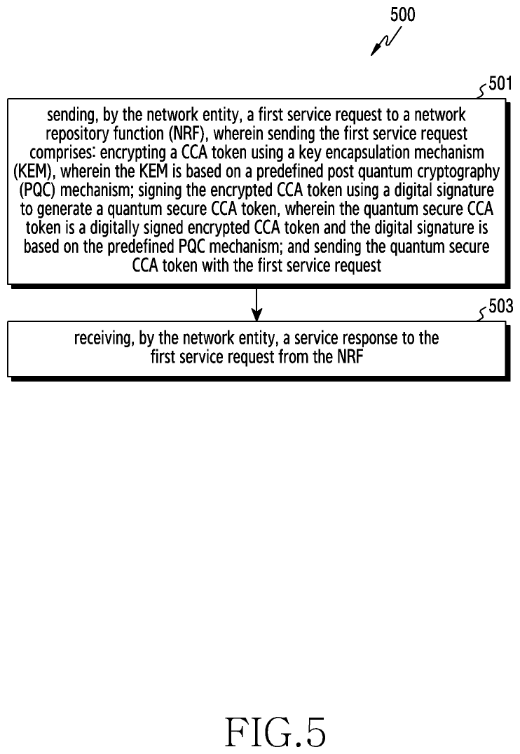

Referring to FIG. 4, at operation 402, the NF service consumer 301 transmits a service request using a quantum secure CCA token to the SCP 303. The CCA token is encrypted with a PQC/Hybrid PQC-based key encapsulation mechanism (KEM) and is signed using a PQC/Hybrid PQC-based digital signature. At operation 404, the SCP 303 performs a discovery operation to discover the NRF 305. Then, at operation 406, the SCP 303 transmits a Nnrf_AccessToken_Get Request using the quantum secure CCA token, to the NRF 305. At operation 408, the NRF 305 (decrypts the CCA token and validates the signature of the CCA token using PQC/hybrid PQC-based mechanisms. At operation 410, the NRF 305 transmits Nnrf_AccessToken_Get Response to the SCP 303. At operation 412, the SCP 303 transmits the service response to the NF service consumer 301. This embodiment is further explained in reference to FIG. 5.

FIG. 5 illustrates a flow diagram depicting a method for performing CCA based authentication and authorization of a network entity, according to an embodiment of the disclosure. FIG. 5 will be explained in conjunction with FIG. 4 for the sake of brevity of the description.

In an embodiment, the network entity may be the NF service consumer 301 of FIG. 4. Accordingly, the same reference numeral has been used to represent the network entity.

Referring to FIG. 5, at operation 501, method 500 includes sending a first service request to an NRF 305. The first service request may correspond to the service request at operation 402 of FIG. 4. As shown in FIG. 4, a network entity (e.g., NF service consumer) 301 sends the first service request with the CCA token. The CCA token is encrypted using a key encapsulation mechanism (KEM). In an embodiment, the KEM is based on a predefined post quantum cryptography (PQC) mechanism. In an embodiment, the predefined PQC mechanism is one of a PQC mechanism and a hybrid PQC mechanism. The predefined PQC mechanism is described in detail hereafter. After encrypting the CCA token, the network entity (e.g., NF service consumer) 301 generates a quantum secure CCA token. The generated quantum secure CCA token is a digitally signed encrypted CCA token that is signed using a digital signature. In an embodiment, the digital signature is based on the predefined PQC mechanism.

Thereafter, at operation 503, the method 500 includes receiving a service response to the first service request from the NRF 305. As shown in FIG. 4, the service request comprising the quantum secure CCA token is decrypted using a decryption technique, wherein the decryption technique is based on the predefined PQC mechanism. The service response is determined based on the decryption, which is then received at the network entity. In a further embodiment, the network entity (e.g., NF service consumer) 301 is first authenticated and authorized by validating the digital signature of the decrypted quantum secure CCA token. Then, the service response is determined based on the validation of the network entity (e.g., NF service consumer) 301. In an embodiment, as shown in FIG. 4, the NRF 305 may be communicably coupled with the network entity (e.g., NF service consumer) 301 via a first SCP 303-1, wherein the first SCP 303-1 supports the PQC mechanism. Accordingly, the network entity (e.g., NF service consumer) 301 may be authenticated by validating the digital signature of the quantum secure CCA token at the first SCP 303-1.

In an embodiment, the hybrid PQC mechanism based KEM may include a combination of quantum safe crypto KEM algorithms with legacy KEM algorithms like ECDH. Similar to hybrid key exchange in Transport Layer Security (TLS), 3GPP can also adopt such methodologies to combine two algorithms for enhanced security protection and to support fall back mechanisms when one of the two algorithms gets broken in the future. The shared key of one algorithm can be combined with other algorithms to form a new shared key for hybrid mechanisms. These new hybrid protection mechanisms can be added in addition to PQC algorithms. A few examples of the hybrid PQC mechanism based KEM are discussed below:

Example 1: Legacy+PQC KEM Profile. In this hybrid PQC mechanism based KEM, one algorithm can be of the legacy type, such as an elliptical curve based protection scheme identifier, and the other can be a post quantum KEM based scheme identifier. Any combination of the legacy elliptical based scheme and below mentioned PQC KEM based schemes are possible to be constructed as mentioned below:
ECDH+KYBER,
ECDH+BIKE
ECDH+Classic McEliece
RSA+KYBER

Example 2: PQC KEM+PQC KEM Profile. In this hybrid PQC mechanism based KEM, both KEM algorithms can be of post quantum type, i.e. both are Post Quantum Cryptography KEM based scheme identifiers such as:
KYBER+BIKE
KYBER+HQC
KYBER+Classic McEliece
BIKE+HQC
BIKE+Classic McEliece
HQC+Classic McEliece

Similarly, the hybrid PQC mechanism based digital signature algorithms may include a combination of quantum safe crypto digital signature algorithms with legacy digital signature algorithms like RSA and ECDSA. A few examples of the hybrid PQC mechanism based digital signature are discussed below:

Example 1: PQC KEM+PQC Digital Signature Profile. In this hybrid PQC mechanism based digital signature, one algorithm can be of post quantum type KEM and the other can be a post quantum cryptography digital signature based scheme identifier, such as:
KYBER+Di-lithium/FALCON/SPHINCS+
BIKE+Di-lithium/FALCON/SPHINCS+
KYBER+Di-lithium/FALCON/SPHINCS+
Classic McEliece+Di-lithium/FALCON/SPHINCS+

Example 2: Legacy+PQC Digital Signature Profile. In this hybrid PQC mechanism based digital signature, one algorithm can be of the legacy type, i.e. elliptical curve based protection scheme identifier, and other can be Post Quantum based digital signature scheme identifier, such as
ECDH+Di-lithium/FALCON/SPHINCS
RSA+Di-lithium/FALCON/SPHINCS+

It should be noted that the above-discussed profiles represent only a few examples of the hybrid PQC mechanism based KEM and hybrid PQC mechanism based digital signature. Any other combination of the legacy algorithm and the PQC mechanism may be used as the hybrid PQC mechanism based KEM and the hybrid PQC mechanism based digital signature.

In an embodiment, JWE, JWS network Profile based on PQC based mechanism and hybrid PQC based mechanism shall be added in the 3GPP standard. Further, the following modifications are required to incorporate the disclosed embodiments in the 3GPP technical specification (TS), 33.210:
a. JWE Related Profile:
   i. All entities and functions that support JWE according to RFC 7516 shall follow the following restrictions and extensions:
   ii. Key Exchange should happen either using a PQC based mechanism, hybrid mechanism, or quantum safe homomorphic algorithm.
b. JWS Related Profile:
   i. All entities and functions that support JWS according to RFC 7515 shall follow the following restrictions and extensions:
   ii. The digital signature should happen using PQC based digital signature algorithms, hybrid based digital signature algorithms or quantum safe homomorphic digital signature algorithms.

Further, it is necessary to add a TLS network Profile based on PQC based mechanism and a hybrid PQC based mechanism. Further, the following modifications are required to incorporate the disclosed embodiments in the 3GPP technical specification (TS), 33.210:
1) TLS 1.3 cipher-suite shall follow the requirements given in section 9.1 of TLS 1.3 RFC 8446 [66]. In addition, a key exchange should happen either using PQC based mechanism, hybrid mechanism, or quantum safe homomorphic encryption.
2) TLS 1.3 signature scheme shall follow PQC-Digital-Signature_PQC-KEM_sha3843)
3) TLS 1.2 cipher-suite shall follow the rules on allowed cipher suites given in TLS 1.2 (RFC 5246 [50]). Further, TLS 1.2 cipher-suite shall follow TLS_PQC-KEM_PQC-Digital-Signature_WITH_AES_256_GCM_SHA384
4) TLS 1.2 signature scheme shall follow PQC-Digital-Signature_PQC-KEM_sha384

The disclosed technique has an impact on the 3GPP standard, as shown in below Table 1:

TABLE 1

| | |
|---|---|
| 0x0: Null-Scheme | Size of input, i.e., size of username used in |
| | case of NAI format or MSIN in case of IMSI |
| 0x1: ECIES | Total of 256-bit public key, 64-bit MAC, plus |
| Profile <A> | size of input. |
| 0x2: ECIES | Total of 264-bit public key, 64-bit MAC, plus |
| Profile <B> | size of input. |
| 0x3: KYBER | Total of 768/1088/1568 byte ciphered shared key, |
| | 64-bit MAC, plus the size of input |
| 0x4: BIKE | Total of 1572/3114 byte ciphered shared key, |
| | 64-bit MAC, plus the size of input |
| 0x5: Classic | Total of 128/188/240 byte ciphered shared key, |
| McEliece | 64-bit MAC, plus the size of input |
| 0x6: HQC | Total of 4481/9026/14469 byte ciphered shared |
| | key, 64-bit MAC, plus the size of input |
| 0x7: SIKE | Total of 346/486/596 byte ciphered shared key, |
| | 64-bit MAC, plus the size of input |
| 0x8: Dilithium | NIST standardized Digital Signature |
| | based algorithm |
| 0x9: FALCOM | NIST standardized Digital Signature |
| | based algorithm |
| 0xA: SPHINCS+ | NIST standardized Digital Signature |
| | based algorithm |

The values 0xB are reserved for future standardized protection schemes. The values 0xC-0xF are reserved for proprietary protection schemes specified by the home operator.

In an embodiment, a common profile for each algorithm of in KEM and digital signature can be provisioned. In an embodiment, such a profile for KYBER has been shown in below Table 2:

TABLE 2
KYBER

| Parameter | Value |
|---|---|
| KDF | ANSI-X9.63-KDF [29] |
| Hash | SHA-256 |
| SharedInfo1 | Encrypted Eph. Shared key octet string |
| MAC | HMAC-SHA-256 |
| mackeylen | 32 octets (256 bits) |
| maclen | 8 octets (64 bits) |
| SharedInfo2 | the empty string |
| ENC | AES-128 in CTR mode or AES-256 (with |
| | or without CTR) |
| enckeylen | 16 octets (128 bits) |
| icblen | 16 octets (128 bits) |
| backwards compatibility | FALSE |
| mode | |

In an embodiment, various parameters of each algorithm in KEM and digital signature can be adjusted according to the Level of security (1, 3, 5, etc.). In an embodiment, such adjustment for KYBER has been shown in below Table 3:

TABLE 3

| | |
|---|---|
| Parameter | Value |

Level of security (1): KYBER512

| | |
|---|---|
| Bits of entropy (n) | 256 |
| Prime number (q) | 3329 |
| k (lattice dimension) | 2 |
| Noise parameter (n1) | 3 |
| Noise parameter (n2) | 2 |
| Encode/Decode Parameters (du, dv) | 10, 4 |
| Failure Probability (Delta) | 2\hat{ }(−139) |

Level of security (3): KYBER768

| | |
|---|---|
| Bits of entropy (n) | 256 |
| Prime number (q) | 3329 |
| k (lattice dimension) | 3 |
| Noise parameter (n1) | 2 |
| Noise parameter (n2) | 2 |
| Encode/Decode Parameters (du, dv) | 10, 4 |
| Failure Probability (Delta) | 2\hat{ }(−164) |

Level of security (5): KYBER1024

| | |
|---|---|
| Bits of entropy (n) | 256 |
| Prime number (q) | 3329 |
| k (lattice dimension) | 4 |
| Noise parameter (n1) | 2 |
| Noise parameter (n2) | 2 |
| Encode/Decode Parameters (du, dv) | 11, 5 |
| Failure Probability (Delta) | 2\hat{ }(−174) |

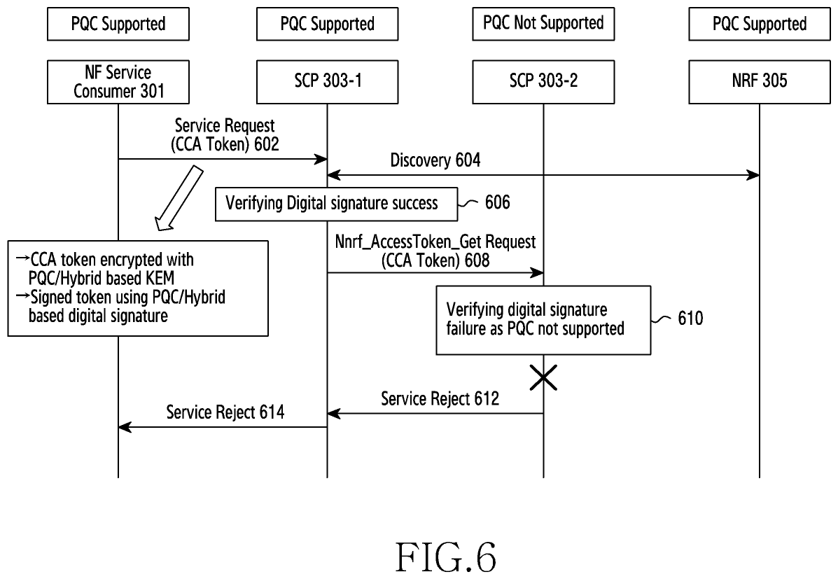

FIG. 6 illustrates a problem scenario associated with incompatibilities between network function (NF) and service communication proxy (SCP), according to an embodiment of the disclosure.

Migration towards security solutions based on quantum-safe cryptographic algorithms is unavoidable due to a rise in quantum attacks. While migrating to quantum-safe algorithms, one SCP may support quantum-safe algorithms only while the other SCP may support legacy-based crypto algorithms. Since currently this is not communicated during the negotiation of security mechanisms between the NEs and all intermediate SCPs, it leads to verification failure of digital signature due to algorithm mismatch. This leads to communication failure between NFs or between NF and NRF, which is explained in reference to FIG. 6.

Referring to FIG. 6, at operation 602, an NF service consumer 301 transmits a service request using a secure CCA token to a first SCP 303-1. As shown in FIG. 6, the first SCP 303-1 supports the PQC mechanism. Accordingly, the CCA token is encrypted with a PQC/Hybrid PQC-based key encapsulation mechanism (KEM) and is signed using a PQC/Hybrid PQC-based digital signature. At operation 604, the first SCP 303-1 performs a discovery operation to discover the NRF 305. At operation 606, the first SCP 303-1 verifies the digital signature of the CCA token. Then, at operation 608, the first SCP 303-1 transmits a Nnrf_AccessToken_Get Request using the quantum secure CCA token, to a second SCP 303-2. At operation 610, as the second SCP 303-2 does not support PQC mechanism, the verification of the digital signature of the CCA token fails. At operation 612, the second SCP 303-2 transmits a service reject to the first SCP 303-1. At operation 614, the first SCP 303-1 transmits the service reject to the NF service consumer 301.

The disclosure provides two solutions to the problem discussed in reference to FIG. 6.

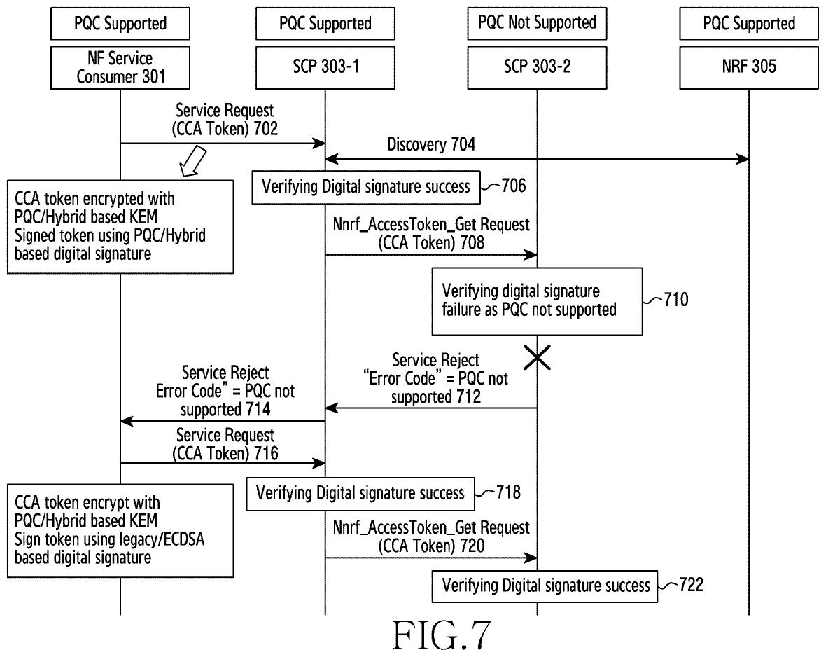

FIG. 7 illustrates a first solution scenario corresponding to the problem scenario of FIG. 6, according to an embodiment of the disclosure. Particularly, FIG. 7 illustrates a sequence flow diagram of a solution to use rejection cause codes in CCA, according to an embodiment of the disclosure.

Referring to FIG. 7, at operation 702, the NF service consumer 301 transmits a service request using a secure CCA token to a first SCP 303-1. As shown in FIG. 7, the first SCP 303-1 supports PQC. Accordingly, the CCA token is encrypted with a PQC/Hybrid PQC-based key encapsulation mechanism (KEM) and is signed using a PQC/Hybrid PQC-based digital signature. In an embodiment, the CCA token is the quantum secure CCA token, as discussed in reference to FIG. 5. At operation 704, the first SCP 303-1 performs a discovery operation to discover the NRF 305. At operation 706, the first SCP 303-1 verifies the digital signature of the quantum secure CCA token. Then, at operation 708, the first SCP 303-1 transmits a Nnrf_AccessToken_Get Request using the quantum secure CCA token, to a second SCP 303-2. At operation 710, as the second SCP 303-2 does not support PQC, the verification of the digital signature of the CCA token fails. In an embodiment, a rejection/error code can be added in a service reject response in case of authentication failure with a CAUSE value indicating the reason for failure. The error code may indicate the authorization failure at the second SCP 303-2 due to a lack of support for PQC. Accordingly, at operation 712, the second SCP 303-2 transmits the service reject response including the error code, i.e., “Error Code”=PQC not supported, to the first SCP 303-1. At operation 714, the first SCP 303-1 transmits the service reject code to the NF service consumer 301. Based on the error code in the service reject message, the NF service consumer 301 can reinitiate the CCA token while keeping PQC/Hybrid KEM as the encryption method but signing the CCA token with an ECDSA/RSA-based signature. Accordingly, at operation 716, the NF service consumer 301 transmits a second service request using a CCA token which is encrypted using the predefined PQC based KEM but signed with a predefined elliptic curve cryptography (ECC), such as ECDSA/RSA. At operation 718, the first SCP 303-1 verifies the signature. Then, at operation 720, the first SCP 303-1 transmits a Nnrf_AccessToken_Get Request using the revised CCA token to the second SCP 303-2. As the CCA token is digitally signed using the legacy algorithms, the second SCP 303-2 successfully verifies the signature, at operation 722. However, in order to inform the NF service consumer 301 about the second SCP 303-2 not supporting PQC, a service reject with a rejection code may be added in the 3GPP technical specification (TS), 33.501. The service rejection code may be defined as:
Service_reject_cause=001 (or XXX) indicating ‘PQC not supported’

It should be noted that the CCA token can be encrypted and digitally signed in a similar way as discussed in reference to FIG. 5.

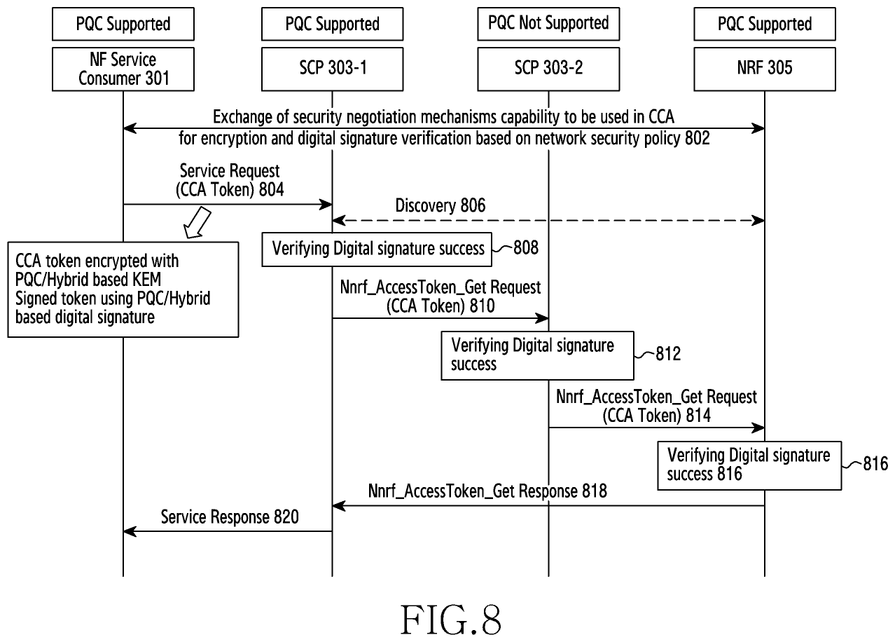

FIG. 8 illustrates a second solution scenario corresponding to the problem scenario of FIG. 6, according to an embodiment of the disclosure. Particularly, FIG. 8 illustrates a sequence flow diagram of a solution to use to use network security policy in CCA, according to an embodiment of the disclosure.

In an embodiment, a new network security policy may be implied at NF Producer, SCP, NF Consumer, and NRF about the preferred PQC authentication protection and signature verification mechanism. The exchange of security negotiation mechanisms capability can be used in CCA for encryption and digital signature verification based on the network security policy.

Referring to FIG. 8, at operation 802, negotiation information between the network entity and the NRF is exchanged. In an embodiment, the network entity may refer to the NF service consumer 301, the first SCP 303-1, and the second SCP 303-2. If the NF service consumer 301 and the NRF 305 are communicating via any of the SCPs, then the negotiation information is exchanged between the NF service consumer 301, the SCPs 303-1, 303-2, and the NRF 305, as shown in FIG. 8. However, if the NF service consumer 301 and the NRF 305 are not communicating via any of the SCPs, then the negotiation information is exchanged between the NF service consumer 301 and the NRF 305. In an embodiment, the negotiation information is indicative of one of a plurality of security policies to be used for digitally signing the CCA token for authentication and authorization of the network entity. In an embodiment, the plurality of security policies may include a PQC authentication required policy, a PQC authentication preferred policy, and a PQC authentication unwarranted policy. The PQC authentication required policy indicates that network entity supports only PQC authentication and verification mechanism the network entity supports only PQC authentication and verification mechanism. The PQC authentication preferred policy indicates that the network entity supports both PQC and legacy authentication and verification mechanisms. The PQC authentication unwarranted policy indicates that the network entity supports legacy authentication and verification mechanisms. Further, even if either of the network entity and the NRF does not support PQC by mentioning PQC security policy as “unwarranted”, security key and parameters exchange may be done using legacy methods to avoid later rejections. Also, SCPs can forward consumer requests to a compatible SCP that supports the security mechanism accordingly. Early detection of supported security mechanisms can decrease communication latency between NFs or between NFs and NRF. Based on security policy and cipher suite supported by entities, Parameters, and keys for shared secret and signature algorithms can be negotiated. A single bit support of PQC/Legacy authentication indication bit can be supported otherwise while negotiating security policy.

At operation 804, the NF service consumer 301 transmits a service request using a secure CCA token to a first SCP 303-1 after exchanging the negotiation information. In an embodiment, the service request refers to the first service request of FIG. 4. The first service request is sent with the CCA token, wherein the CCA token is encrypted using the predefined PQC based KEM. In an embodiment, the encrypted CCA token is digitally signed based on the exchanged negotiation information. At operation 806, the first SCP 303-1 performs a discovery operation to discover the NRF 305. At operation 808, the first SCP 303-1 verifies the digital signature of the CCA token. Then, at operation 810, the first SCP 303-1 transmits a Nnrf_AccessToken_Get Request using the CCA token, to a second SCP 303-2. At operation 812, the second SCP 303-2 verifies the digital signature of the CCA token. Then, at operation 814, the second SCP 303-2 transmits a Nnrf_AccessToken_Get Request using the CCA token to the NRF 305. At operation 816, the NRF verifies the digital signature of the CCA token. At operation 818, the NRF 305 transmits a Nnrf_AccessToken_Get Response to the first SCP 303-1. At operation 820, the first SCP 303-1 transmits a service response to the NF service consumer 301.

In an embodiment, the following may be made to incorporate the embodiment disclosed in reference to FIGS. 7 and 8, in related techniques, such as the 3GPP technical specification (TS), 33.501:

### 13.3.8.2 Client Credentials Assertion

a. CCAs shall be JSON Web Tokens as described in RFC 7519 [44] and are secured with digital signatures based on JSON Web Signature (JWS) as described in RFC 7515 [45].
b. The CCA shall include:
   i. The NF instance ID of the NF Service Consumer (subject);
   ii. A timestamp (iat) and an expiration time (exp), and
   iii. The NF type of the expected audience (audience), i.e. the type “NRF” and/or the NF type of the NF Service Producer.
   iv. “PQC Support”, this parameter indicates the access token signing method.
      a. 0 means legacy method
      b. 1 means PQC method
   v. The NF service consumer shall digitally sign the generated CCA based on its private key as described in RFC 7515 [45]. The signed CCA shall include one of the following fields: the X.509 URL (x5u) to refer to a resource for the X.509 public key certificate or certificate chain used for signing the client authentication assertion, or the X.509 Certificate Chain (x5c) include the X.509 public key certificate or certificate chain used for signing the client authentication assertion.
   vi. Security policy indicates PQC authentication Protection “required/preferred/unwarranted”

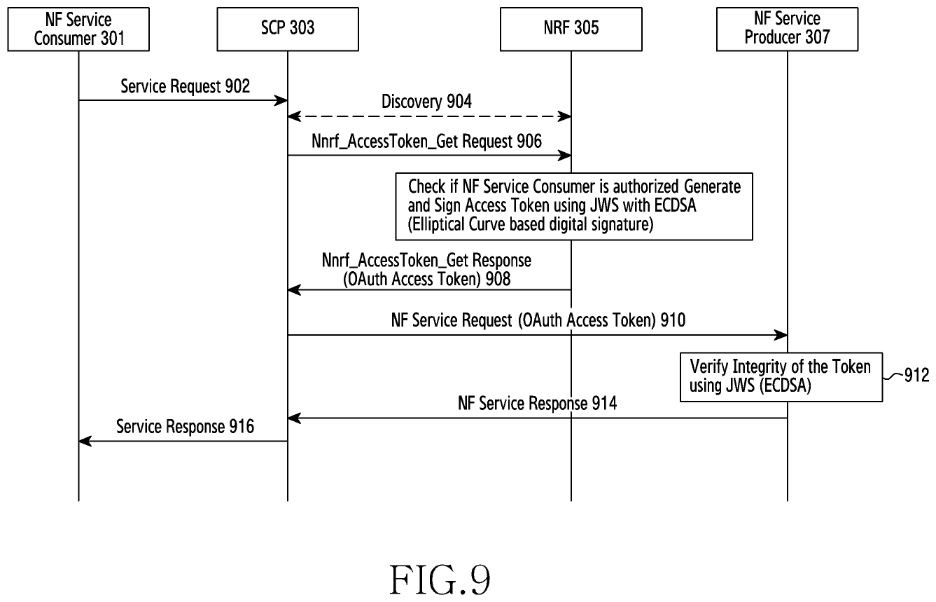

FIG. 9 illustrates a problem scenario associated with insecure cryptographic algorithms in the OAuth interface, according to an embodiment of the disclosure.

One problem in the security and authentication mechanisms in the 5G wireless communication system is not having quantum safe mechanisms in encryption and authentication of OAuth tokens between NFs, SCPs, and NRF. The NF service consumer requests the NRF for an access token to access the NF service producer. The NF service consumer may request the NRF Via ScP and NRF, as shown in FIG. 9.

Referring to FIG. 9, at operation 902, the NF service consumer 301 transmits a service request to an SCP 303. At operation 904, the SCP 303 performs a discovery operation to discover the NRF 305. At operation 906, the SCP 303 transmits the Nnrf_AccessToken_Get Request to the NRF 305. The NRF 305 generates the access token and signs it using Java Web Signature (JWS) with ECDSA or RSA as described in RFC 7515, which is not quantum safe either. The NRF 305 also checks if the NF service consumer 301 is authorized. At operation 908, the NRF 305 transmits a Nnrf_AccessToken_Get Response with an OAuth access token to the SCP 303. At operation 910, the SCP 303 transmits an NF Service Request with the OAuth access token. At operation 912, an NF service producer 307 verifies the integrity of the OAuth access token using JWS (ECDSA). At operation 914, the NF service producer 307 transmits the NF Service Response to the SCP 303, which is then forwarded to the NF service consumer 301 at operation 916.

However, the attackers using quantum machines can break these legacy digital signature based algorithms and perform man in the middle (MITM), impersonation attacks, and spoofing where the attacker acts as the NF consumer and requests various services from different NFs, including private and sensitive information like various Authentication Vectors, Cryptographic material, location information like, e.g., Cell ID and Physical Cell ID. Hence, securing the OAuth access tokens with quantum safe crypto algorithms in 6G wireless communication system mitigates such kinds of attacks.

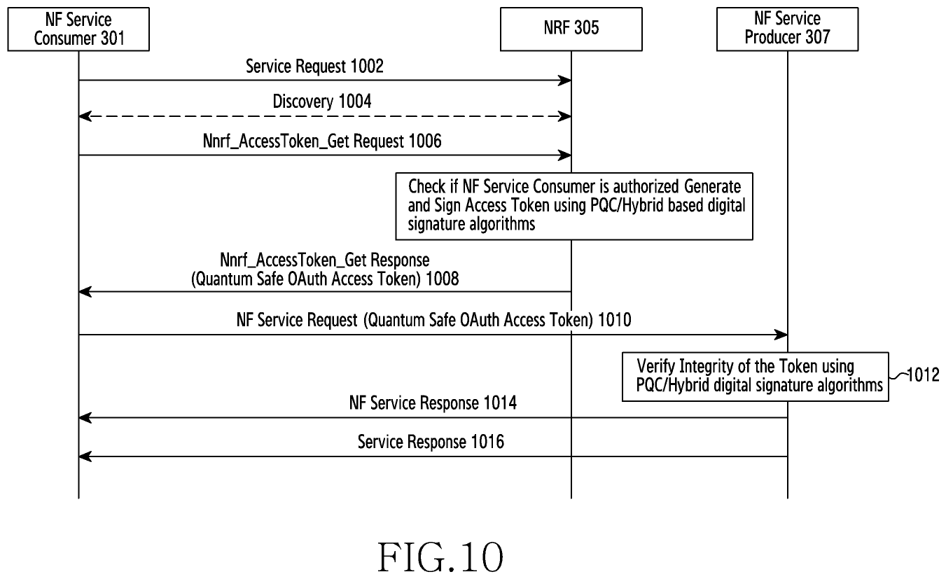

FIG. 10 illustrates a solution scenario corresponding to the problem scenario of FIG. 9, according to an embodiment of the disclosure.

Embodiments herein define a mechanism for replacing legacy algorithms with cipher suites, and signatures of quantum safe crypto algorithms into the OAuth authentication and authorization procedures of 6G wireless communication systems. The quantum safe crypto algorithm as disclosed herein refers to one of the post quantum cryptography algorithms, hybrid algorithm, and any quantum safe homomorphic algorithm. The hybrid algorithms may refer to the same hybrid algorithm as discussed in reference to FIG. 5. Hence, the description of the same is omitted here for the sake of brevity of the description.

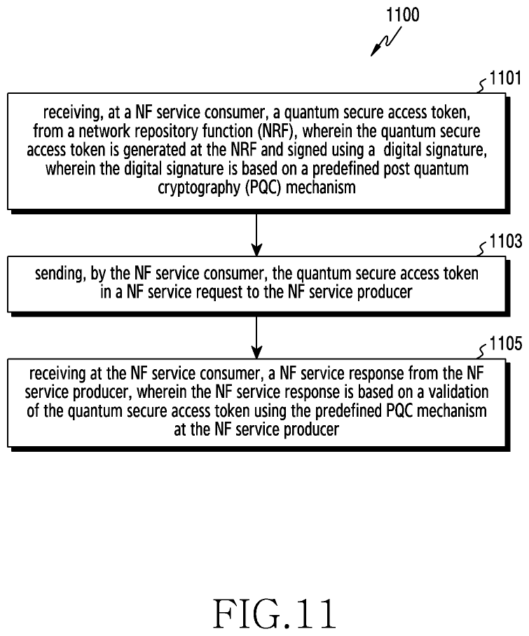

Referring to FIG. 10, at operation 1002, the NF service consumer 301 transmits a service request to the NRF 305. At operation 1004, the NF service consumer 301 performs a discovery operation to discover the NRF 305. At operation 1006, the NF service consumer 301 transmits the Nnrf_AccessToken_Get Request to the NRF 305 to obtain a quantum secure access token, also referred to as a quantum safe OAuth access token. The NRF 305 generates the quantum secure access token and signs it using the predefined PQC based digital signature. The NRF 305 also checks if the NF service consumer 301 is authorized. At operation 1008, the NRF 305 transmits a Nnrf_AccessToken_Get Response with the quantum safe OAuth access token to the NF service consumer 301. At operation 1010, the NF service consumer 301 transmits an NF Service Request with the quantum safe OAuth access token to the NF service producer 307. At operation 1012, the NF service producer 307 verifies the integrity of the OAuth access token using the predefined PQC based digital signature. At operation 1014, the NF service producer 307 transmits the NF Service Response to the NF service consumer 301. At operation 1016, the NRF 305 transmits a service response to the NF service consumer 301. This embodiment is further explained in reference to FIG. 11.

FIG. 11 illustrates a flow diagram depicting a method for accessing service provided by the NF service producer, according to an embodiment of the disclosure. FIG. 11 will be explained in conjunction with FIG. 10 for the sake of brevity of the description.

Referring to FIG. 11, at operation 1101, method 1100 may include receiving, at the NF service consumer 301, a quantum secure access token, from the NRF 305. The NF service consumer 301 may receive the quantum secure access token in accordance with the technique as discussed in reference to FIG. 10. In an embodiment, the quantum secure access token is generated at the NRF and signed using a digital signature, which is based on the predefined PQC mechanism. At operation 1103, the method 100 may include sending, by the NF service consumer 301, the quantum secure access token in an NF service request to the NF service producer 307. The NF service consumer 301 may send the quantum secure access token to the NF service producer 307 in accordance with the technique as discussed in reference to FIG. 10. Then, at operation 1105, the method 1100 may include receiving, at the NF service consumer 301, an NF service response from the NF service producer 307, wherein the NF service response is based on a validation of the quantum secure access token using the predefined PQC mechanism at the NF service producer 307. This step may be performed in accordance with the technique as discussed in reference to FIG. 10.

In an embodiment, the predefined PQC based mechanism is the same as discussed in reference to FIG. 5. Hence, the description of the same is omitted here for the sake of brevity of the description.

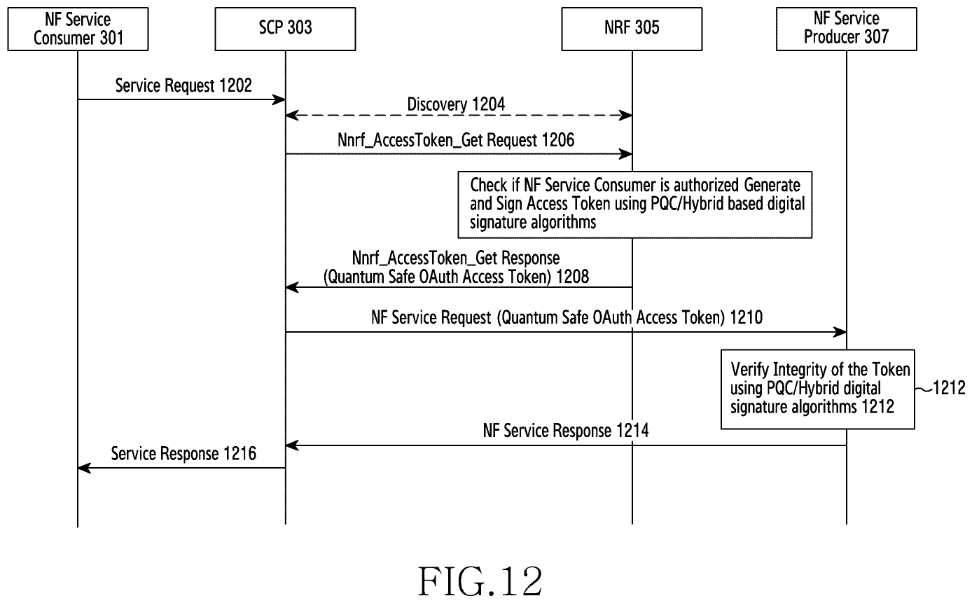

FIG. 12 illustrates a solution scenario corresponding to the problem scenario of FIG. 9, according to an embodiment of the disclosure.

Referring to FIG. 12, in an embodiment of the disclosure, an NF service consumer 301 may communicate with an NRF 305 via an SCP 303. At operation 1202, the NF service consumer 301 transmits a service request to the SCP 303. At operation 1204, the SCP 303 performs a discovery operation to discover the NRF 305. At operation 1206, the SCP 303 transmits an Nnrf_AccessToken_Get Request to the NRF 305 to obtain a quantum secure access token, also referred to as a quantum safe OAuth access token. The NRF 305 generates the quantum secure access token and signs it using the predefined PQC based digital signature. The NRF 305 also checks if the NF service consumer 301 is authorized. At operation 1208, the NRF 305 transmits a Nnrf_AccessToken_Get Response with the quantum safe OAuth access token to the NF service consumer 301. At operation 1210, the SCP 303 transmits an NF Service Request with the quantum safe OAuth access token to the NF service producer 307. At operation 1212, the NF service producer 307 verifies the integrity of the OAuth access token using the predefined PQC based digital signature. At operation 1214, the NF service producer 307 transmits the NF Service Response to the SCP 303. At operation 1216, the SCP 303 transmits a service response to the NF service consumer 301.

The following modifications may be made to incorporate the embodiment disclosed in reference to FIGS. 11 and 12, in related techniques, such as the 3GPP technical specification (TS), 33.501:

In an embodiment, JWE, JWS network Profile based on PQC based mechanism and hybrid PQC based mechanism shall be added in the 3GPP standard. Further, the following modifications may be made to incorporate the disclosed embodiments in related techniques, such as the 3GPP technical specification (TS), 33.210:
a. JWE Related Profile:
   i. All entities and functions that support JWE according to RFC 7516 [47] shall follow the following restrictions and extensions:
   ii. Key Exchange should happen either using a PQC based mechanism, hybrid mechanism, or quantum safe homomorphic algorithm.
b. JWS Related Profile:
   i. All entities and functions that support JWS according to RFC 7515 [46] shall follow the following restrictions and extensions:
   ii. The digital signature should happen using PQC based digital signature algorithms, hybrid based digital signature algorithms, or quantum safe homomorphic digital signature algorithms.

Further, a bit to indicate the security policy and PQC support also can be added as mentioned below. In an embodiment, the bit may be added during negotiation information procedure between network entity (e.g., the NF service consumer, the SCP's, etc.) and the NRF.
5.4.2.1 Introduction [TS 29.510]
   The services operations defined for the Nnrf_AccessToken service are Access Token Request (i.e. Nnrf_AccessToken_Get)
5.4.2.2 Get (Access Token Request)
   The OAuth 2.0 Access Token Request includes in the body of the HTTP POST request shall contain:
   An OAuth2 grant type set to “client_credentials”;
   The “scope” parameter indicating the names of the NF Services that the NF Service Consumer is trying to access (i.e., the expected NF service names);
   The NF Instance Id of the NF Service Consumer requesting the OAuth2.0 access token;
   NF type of the NF Service Consumer, if this is an access token request not for a specific NF Service Producer;
   NF type of the expected NF Service Producer, if this is an access token request not for a specific NF Service Producer;
   Security policy indicates PQC authentication Protection “required/preferred/unwarranted”
   Optionally, “PQC Support” parameter can be added to indicate the access token signing method, where.
      0 means legacy method
      1 means PQC/Hybrid method

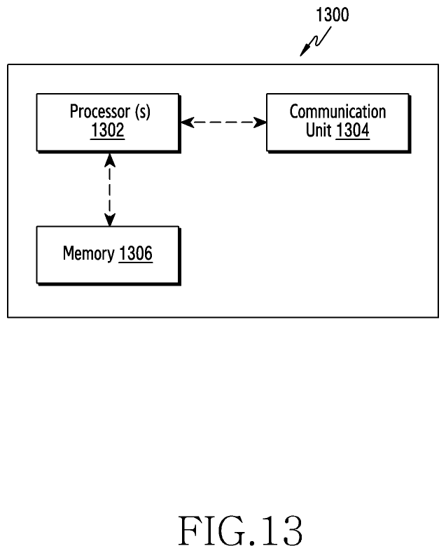

FIG. 13 illustrates a diagram of a system for performing CCA based authentication and authorization of a network entity, according to an embodiment of the disclosure. The configuration of FIG. 13 may be understood as a part of the configuration of the network entity. Further, the method 500 as disclosed above may be implemented in the system of FIG. 13 according to a further embodiment. In an embodiment, the system of FIG. 13 corresponds to the network entity (e.g., NF service consumer) 301.

Referring to FIG. 13, a system 1300 may include at least one processor 1302, a communication circuit 1304 (e.g., communicator or communication interface), and memory 1306. The communication circuit 1304 may perform functions for transmitting and receiving signals via a wireless channel.

As an example, the at least one processor 1302 may be a single processing unit or a number of units, all of which could include multiple computing units. The at least one processor 1302 may be implemented as one or more microprocessors, microcomputers, microcontrollers, digital signal processors, central processing units, state machines, logic circuitries, and/or any devices that manipulate signals based on operational instructions. Among other capabilities, the at least one processor 1302 is configured to fetch and execute computer-readable instructions and data stored in the memory 1306. The at least one processor 1302 may include one or a plurality of processors. At this time, one or a plurality of processors 1302 may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). The one or a plurality of processors 1302 may control the processing of the input data in accordance with a predefined operating rule or Artificial Intelligence (AI) model stored in the non-volatile memory and the volatile memory, i.e., the memory 1306. The predefined operating rule or AI model is provided through training or learning.

The memory 1306 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

Various embodiments are in nature, and the system 1300 may include additional components required to implement the desired functionality of the system 1300 in accordance with the requirements of the disclosure.

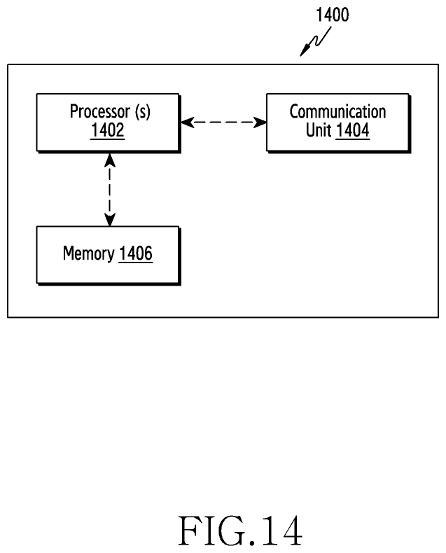

FIG. 14 illustrates a diagram of a system, according to an embodiment of the disclosure.

Referring to FIG. 14, a system 1400 may correspond to any suitable NF service consumer or SCPs as discussed throughout the specification. The system 1400 may be configured to perform the method 1100 as discussed above. The system 1400 may include at least one processor 1402, a communication circuit 1404, and memory 1406.

The communication circuit 1404 may perform one or more functions for transmitting and receiving signals via a wireless channel. The memory 1406 may be configured to store information/data required by the at least one processor 1402 to perform one or more desired functionalities of the system 1400 in accordance with the disclosure.

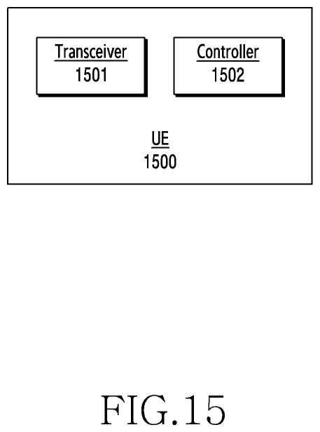

FIG. 15 illustrates a structure of a user equipment according to embodiment of the disclosure.

Referring to FIG. 15, a user equipment 1500 includes a controller 1502 and a transceiver 1501, where the controller 1502 is configured to perform the method performed by the user equipment that is disclosed herein above, and the transceiver 1501 is configured to transmit and receive a channel or a signal. Furthermore, the user equipment 1500 further includes memory (not shown). Additionally, the components of the user equipment 1500 are not limited thereto. For example, the user equipment 1500 may include more or fewer components than those described above. In addition, the controller 1502, the transceiver 1501, and the memory may be implemented as a single chip. Also, the controller 1502 may include at least one processor.

Furthermore, the user equipment 1500 may correspond to an NF service consumer of the system 1400 of FIG. 14, the controller 1502 may correspond to the at least one processor 1402 of FIG. 14, and the transceiver 1501 may correspond to the communication circuit 1404 of FIG. 14.

The transceiver 1501 collectively refers to a UE receiver and a UE transmitter, and may transmit/receive a signal to/from a base station or a network entity. The signal transmitted or received to or from the base station or a network entity may include control information and data. The transceiver 1501 may include a RF transmitter for up-converting and amplifying a frequency of a transmitted signal, and a RF receiver for amplifying low-noise and down-converting a frequency of a received signal. However, this is only an example of the transceiver 1501 and components of the transceiver 1501 are not limited to the RF transmitter and the RF receiver.

Also, the transceiver 1501 may receive and output, to the controller 1502, a signal through a wireless channel, and transmit a signal output from the controller 1502 through the wireless channel.

The memory may store a program and data required for operations of the user equipment 1500. Also, the memory may store control information or data included in a signal obtained by the user equipment 1500. The memory may be a storage medium, such as read-only memory (ROM), random access memory (RAM), a hard disk, a CD-ROM, and a DVD, or a combination of storage media.

The controller 1502 may control a series of controllers such that the user equipment 1500 operates as described above. For example, the transceiver 1501 may receive a data signal including a control signal transmitted by the base station or the network entity, and the controller 1502 may determine a result of receiving the control signal and the data signal transmitted by the base station or the network entity.

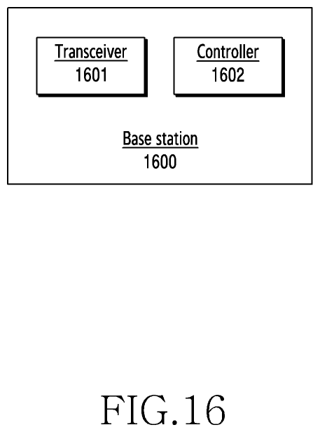

FIG. 16 illustrates a structure of a base station, according to embodiment of the disclosure.

Referring to FIG. 16, a base station 1600 includes a controller 1602 and a transceiver 1601, where the controller 1602 is configured to perform the method performed by the base station that is disclosed herein above, and the transceiver 1601 is configured to transmit and receive a channel or a signal. Furthermore, the base station 1600 further includes memory. Additionally, the components of the base station 1600 are not limited thereto. For example, the base station 1600 may include more or fewer components than those described above. In addition, the controller 1602 and the transceiver 1601 and the memory may be implemented as a single chip. Also, the controller 1602 may include at least one processor.

Furthermore, the base station 1600 may correspond to a SCPs of the system 1400 of FIG. 14, the controller 1602 may correspond to the at least one processor 1402 of FIG. 14, and the transceiver 1601 may correspond to the communication circuit 1404 of FIG. 14.

The transceiver 1601 collectively refers to a base station receiver and a base station transmitter, and may transmit/receive a signal to/from a user equipment or a network entity. The signal transmitted or received to or from the user equipment or a network entity may include control information and data. The transceiver 1601 may include a RF transmitter for up-converting and amplifying a frequency of a transmitted signal, and a RF receiver for amplifying low-noise and down-converting a frequency of a received signal. However, this is only an example of the transceiver 1601 and components of the transceiver 1601 are not limited to the RF transmitter and the RF receiver.

Also, the transceiver 1601 may receive and output, to the controller 1602, a signal through a wireless channel, and transmit a signal output from the controller 1602 through the wireless channel.

The memory may store a program and data required for operations of the base station. Also, the memory may store control information or data included in a signal obtained by the base station. The memory may be a storage medium, such as read-only memory (ROM), random access memory (RAM), a hard disk, a CD-ROM, and a DVD, or a combination of storage media.

The controller 1602 may control a series of processes such that the base station operates as described above. For example, the transceiver 1601 may receive a data signal including a control signal transmitted by the user equipment, and the controller 1602 may determine a result of receiving the control signal and the data signal transmitted by the user equipment.

A method for performing client credential assertion (CCA) based authentication and authorization of a network entity is provided. The method includes sending, by the network entity, a first service request to a network repository function (NRF), wherein sending the first service request comprises: encrypting a CCA token using a key encapsulation mechanism (KEM), wherein the KEM is based on a predefined post quantum cryptography (PQC) mechanism; signing the encrypted CCA token using a digital signature to generate a quantum secure CCA token, wherein the quantum secure CCA token is a digitally signed encrypted CCA token and the digital signature is based on the predefined PQC mechanism; and sending the quantum secure CCA token with the first service request; and receiving, by the network entity, a service response to the first service request from the NRF.

In an embodiment, the service response is determined based on decryption, at the NRF, of the quantum secure CCA token using a decryption technique, wherein the decryption technique is based on the predefined PQC mechanism.

In an embodiment, the service response is determined based on validation of the digital signature of the decrypted quantum secure CCA token such that the network entity is authenticated and authorized.

In an embodiment, the predefined PQC mechanism is one of a PQC mechanism and a hybrid PQC mechanism.

In an embodiment, wherein the NRF is communicably coupled with the network entity via a first service communication proxy (SCP), wherein the first SCP supports PQC, and wherein the network entity is authenticated by validating the digital signature of the quantum secure CCA token at the first SCP.

In an embodiment, the method further comprises: receiving by the network entity, via a first service communication proxy SCP, a service reject response associated with authorization failure at a second SCP, wherein the NRF is communicably coupled with the network entity via the first SCP; wherein the second SCP does not support PQC; wherein validation of the digital signature of the quantum secure CCA token fails at the second SCP; wherein the service reject response includes an error code; and wherein the error code indicates the authorization failure due to a lack of support for PQC.

In an embodiment, the method further comprises: upon receiving the service reject response, sending a second service request, wherein sending the second service request comprises: encrypting the CCA token using the predefined PQC based KEM; signing the encrypted CCA token using a predefined elliptic curve cryptography (ECC) based digital signature; and sending the digitally signed encrypted CCA token with the second service request.

In an embodiment, wherein prior to sending the first service request, the method comprises: exchanging negotiation information between the network entity and the NRF, wherein the negotiation information is indicative of one of a plurality of security policies to be used for digitally signing the CCA token for authentication and authorization of the network entity; and sending the CCA token with the first service request, wherein the CCA token is encrypted using the predefined PQC based KEM, and wherein the encrypted CCA token is digitally signed based on the exchanged negotiation information.

In an embodiment, the plurality of security policies includes a PQC authentication required policy, a PQC authentication preferred policy, and a PQC authentication unwarranted policy.

A method for accessing service provided by a network function (NF) service producer is provided. The method includes receiving, at a NF service consumer, a quantum secure access token, from a network repository function (NRF), wherein the quantum secure access token is generated at the NRF and signed using a digital signature, wherein the digital signature is based on a predefined post quantum cryptography (PQC) mechanism; sending, by the NF service consumer, the quantum secure access token in a NF service request to the NF service producer; and receiving, at the NF service consumer, an NF service response from the NF service producer, wherein the NF service response is based on a validation of the quantum secure access token using the predefined PQC mechanism at the NF service producer.

In an embodiment, the steps of receiving and sending are performed via a service communication proxy (SCP).

In an embodiment, the predefined PQC mechanism is one of a PQC mechanism and a hybrid PQC mechanism.

A network entity for performing client credential assertion (CCA) based authentication and authorization of a network entity is provided. The network entity includes memory; and a processor coupled to the memory and configured to: send a first service request to a network repository function (NRF), wherein the processor sends the first service request by: encrypting a CCA token using a key encapsulation mechanism (KEM), wherein the KEM is based on a predefined post quantum cryptography (PQC) mechanism; signing the encrypted CCA token using a digital signature to generate a quantum secure CCA token, wherein the quantum secure CCA token is a digitally signed encrypted CCA token and the digital signature is based on the predefined PQC mechanism; and sending the quantum secure CCA token with the first service request; and receive a service response to the first service request from the NRF, wherein the service response is determined based on decryption, at the NRF, of the quantum secure CCA token using a decryption technique, wherein the decryption technique is based on the predefined PQC mechanism.

In an embodiment, the service response is determined based on decryption, at the NRF, of the quantum secure CCA token using a decryption technique, wherein the decryption technique is based on the predefined PQC mechanism.

In an embodiment, the service response is determined based on validation of the digital signature of the decrypted quantum secure CCA token such that the network entity is authenticated and authorized.

In an embodiment, the predefined PQC mechanism is one of a PQC mechanism and a hybrid PQC mechanism.

In an embodiment, the NRF is communicably coupled with the network entity via a first service communication proxy (SCP), wherein the first SCP supports PQC, and wherein the network entity is authenticated by validating the digital signature of the quantum secure CCA token at the first SCP.

In an embodiment, the processor is further configured to: receive, via a first service communication proxy SCP, a service reject response associated with authorization failure at a second SCP, wherein the NRF is communicably coupled with the network entity via the first SCP; wherein the second SCP does not support PQC; wherein validation of the digital signature of the quantum secure CCA token fails at the second SCP; wherein the service reject response includes an error code; and wherein the error code indicates the authorization failure due to a lack of support for PQC.

In an embodiment, the processor, upon receiving the service reject response, is configured to: send a second service request, wherein sending the second service request comprises: encrypting the CCA token using the predefined PQC based KEM; signing the encrypted CCA token using a predefined elliptic curve cryptography (ECC) based digital signature; and sending the digitally signed encrypted CCA token with the second service request.

A network entity for accessing service provided by a network function (NF) service producer is provided. The network entity includes memory; and a processor coupled to the memory and configured to: receive a quantum secure access token from a network repository function (NRF), wherein the quantum secure access token is generated at the NRF and signed using a digital signature, wherein the digital signature is based on a predefined post quantum cryptography (PQC) mechanism; send the quantum secure access token in a NF service request to the NF service producer; and receive an NF service response from the NF service producer, wherein the NF service response is based on a validation of the quantum secure access token using the predefined PQC mechanism at the NF service producer.

Accordingly, the disclosure provides techniques for post quantum safe Authentication and Digital signature in the CCA. The techniques are also disclosed for PQC/Hybrid based encryption of CCA token and digital signature of CCA token using PQC/Hybrid algorithms. The techniques are also disclosed to mitigate issues raised in migrating CCA towards post quantum era in 6G. The techniques are also disclosed for providing new rejection cause codes and new security policies for CCA. The techniques are also disclosed for quantum safe signing and verification of OAuth Protocol for beyond 5G/6G systems.

Accordingly, the disclosure provides various advantages. For example, the disclosure provides techniques to secure CCA and OAuth procedures from threats of quantum machines. The disclosed techniques also helps is smooth migration towards quantum safe network, by incorporating hybrid PQC algorithms as a first-mile. The disclosed techniques also avoids service loss, delay during interoperable scenarios during this migration.

Unless otherwise defined, all technical and scientific terms used herein have the same meaning as commonly understood by one of ordinary skilled in the art to which this disclosure belongs. The system, methods, and examples provided herein are illustrative only and not intended to be limiting.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a network entity for performing client credential assertion (CCA) based authentication and authorization of the network entity, the method comprising:
sending, to a network repository function (NRF), a first service request, wherein the sending of the first service request comprises:
encrypting a CCA token using a key encapsulation mechanism (KEM), wherein the KEM is based on a predefined post quantum cryptography (PQC) mechanism,
signing the encrypted CCA token using a digital signature to generate a quantum secure CCA token, wherein the quantum secure CCA token is a digitally signed encrypted CCA token and the digital signature is based on the predefined PQC mechanism, and
sending, to the NRF, the quantum secure CCA token with the first service request; and
receiving, from the NRF, a service response to the first service request.

2. The method of claim 1,
wherein the service response is determined based on decryption of the quantum secure CCA token using a decryption technique, and
wherein the decryption technique is based on the predefined PQC mechanism.

3. The method of claim 1, wherein the service response is determined based on validation of the digital signature of a decrypted quantum secure CCA token such that the network entity is authenticated and authorized.

4. The method of claim 1, wherein the predefined PQC mechanism is one of a PQC mechanism or a hybrid PQC mechanism.

5. The method of claim 1,
wherein the NRF is communicably coupled with the network entity via a first service communication proxy (SCP),
wherein the first SCP supports PQC, and
wherein the network entity is authenticated by validating the digital signature of the quantum secure CCA token at the first SCP.

6. The method of claim 1, further comprising:
receiving, via a first service communication proxy (SCP), a service reject response associated with authorization failure at a second SCP,
wherein the NRF is communicably coupled with the network entity via the first SCP,
wherein the second SCP does not support PQC,
wherein validation of the digital signature of the quantum secure CCA token fails at the second SCP,
wherein the service reject response includes an error code, and
wherein the error code indicates the authorization failure due to a lack of support for PQC.

7. The method of claim 6, further comprising:
in response to receiving the service reject response, sending, a second service request, wherein the sending of the second service request comprises:
encrypting the CCA token using the KEM,
signing the encrypted CCA token using a predefined elliptic curve cryptography (ECC) based digital signature, and
sending the digitally signed encrypted CCA token with the second service request.

8. The method of claim 1, further comprising:
prior to sending the first service request, exchanging negotiation information between the network entity and the NRF, wherein the negotiation information is indicative of one of a plurality of security policies to be used for digitally signing the CCA token for authentication and authorization of the network entity, and sending the CCA token with the first service request,
wherein the CCA token is encrypted using the KEM, and
wherein the encrypted CCA token is digitally signed based on the exchanged negotiation information.

9. The method of claim 8, wherein the plurality of security policies include a PQC authentication required policy, a PQC authentication preferred policy, and a PQC authentication unwarranted policy.

10. A method performed by a network function (NF) service consumer for accessing service provided by an NF service producer, the method comprising:
receiving, from a network repository function (NRF), a quantum secure access token, wherein the quantum secure access token is generated by the NRF and signed using a digital signature, wherein the digital signature is based on a predefined post quantum cryptography (PQC) mechanism;
sending, to the NF service producer, the quantum secure access token in an NF service request; and
receiving, from the NF service producer, an NF service response, wherein the NF service response is based on a validation of the quantum secure access token using the predefined PQC mechanism at the NF service producer.

11. The method of claim 10, wherein the receiving and the sending are performed via a service communication proxy (SCP).

12. The method of claim 10, wherein the predefined PQC mechanism is one of a PQC mechanism or a hybrid PQC mechanism.

13. A network entity for performing client credential assertion (CCA) based authentication and authorization of the network entity, the network entity comprising:
memory; and
a processor coupled to the memory and configured to:
send a first service request to a network repository function (NRF), wherein the processor sends the first service request by:
encrypting a CCA token using a key encapsulation mechanism (KEM), wherein the KEM is based on a predefined post quantum cryptography (PQC) mechanism;
signing the encrypted CCA token using a digital signature to generate a quantum secure CCA token, wherein the quantum secure CCA token is a digitally signed encrypted CCA token and the digital signature is based on the predefined PQC mechanism; and
sending, to the NRF, the quantum secure CCA token with the first service request, and
receive, from the NRF, a service response to the first service request,
wherein the service response is determined based on decryption of the quantum secure CCA token using a decryption technique, and
wherein the decryption technique is based on the predefined PQC mechanism.

14. The network entity of claim 13,
wherein the service response is determined based on decryption of the quantum secure CCA token using a decryption technique, and
wherein the decryption technique is based on the predefined PQC mechanism.

15. The network entity of claim 13, wherein the service response is determined based on validation of the digital signature of a decrypted quantum secure CCA token such that the network entity is authenticated and authorized.

16. The network entity of claim 13, wherein the predefined PQC mechanism is one of a PQC mechanism or a hybrid PQC mechanism.

17. The network entity of claim 13,
wherein the NRF is communicably coupled with the network entity via a first service communication proxy (SCP),
wherein the first SCP supports PQC, and
wherein the network entity is authenticated by validating the digital signature of the quantum secure CCA token at the first SCP.

18. The network entity of claim 13,
wherein the processor is further configured to:
receive, via a first service communication proxy (SCP), a service reject response associated with authorization failure at a second SCP,
wherein the NRF is communicably coupled with the network entity via the first SCP,
wherein the second SCP does not support PQC,
wherein validation of the digital signature of the quantum secure CCA token fails at the second SCP,
wherein the service reject response includes an error code, and
wherein the error code indicates the authorization failure due to a lack of support for PQC.

19. The network entity of claim 18,
wherein the processor is configured to:
in response to receiving the service reject response, send a second service request, and
wherein the sending of the second service request comprises:
encrypting the CCA token using the KEM,
signing the encrypted CCA token using a predefined elliptic curve cryptography (ECC) based digital signature, and
sending the digitally signed encrypted CCA token with the second service request.

20. A network entity for accessing service provided by a network function (NF) service producer, the network entity comprising:
memory; and
a processor coupled to the memory and configured to:
receive a quantum secure access token from a network repository function (NRF), wherein the quantum secure access token is generated by the NRF and signed using a digital signature, wherein the digital signature is based on a predefined post quantum cryptography (PQC) mechanism,
send, to the NF service producer, the quantum secure access token in an NF service request, and
receive, from the NF service producer, an NF service response, wherein the NF service response is based on a validation of the quantum secure access token using the predefined PQC mechanism at the NF service producer.
